(19) United States
(12) Patent Application Publication
(10) Pub. No.: US 2017/0185369 A1
(43) Pub. Date: Jun. 29, 2017

(54) AUDIO CONTENT SURFACED WITH USE OF AUDIO CONNECTION

(71) Applicant: Google Inc., Mountain View, CA (US)

(72) Inventors: Chorong Johnston, Mountain View, CA (US); Sarah Needham, San Francisco, CA (US); Jeff Chow, Newton, MA (US)

(21) Appl. No.: 14/980,938

(22) Filed: Dec. 28, 2015

(51) Int. Cl. G06F 3/16; H04R 1/10

(52) U.S. Cl. CPC G06F 3/165; H04R 1/1041; H04R 2420/05

(57) ABSTRACT

In a user device, a determination may be made as to whether an audio output device has been connected to an audio port of the user device. When it is determined that the connection has been made, instructions may be sent to a server, instructing the server to identify only audio content. The audio content identified by the server may be identified by the server in a manner consistent with preferences of the user. The server may send one or more identifiers of the audio content to a user interface of the user device. A selection of a particular audio content item in the audio content may be received at the user device. The corresponding audio content may be received from the server. The audio content may be output via the audio port of the user device. The determining of whether a connection has been made to an audio port, the instructing of the server by the user device, and receiving may be performed by an aggregator application executing on the user device.

### BACKGROUND

Multi-media content is available over a network (e.g., the Internet) from a variety of content providers. These providers may include news organizations, entertainment providers, and social media services, for example. The content may take any of several forms and may include text, images, video, and/or audio content.

A user may access this content through any of several end user devices, such as a desktop computer, a laptop computer, a tablet, a smartphone, or a wearable computing device for example. This access may be provided through an application running on the user device. The application may operate as a content aggregator, in that various content from assorted content providers may be accessed through a user interface of this application. With the end user device executing the aggregator application, the user may read articles from a newspaper's on-line outlet, see pictures related to these articles, watch videos from a local television station, and/or listen to music from an on-line music source, all through a single application.

Modern user devices generally have hardware that enables such content consumption. A visual display is typically present in such devices. In addition, one or more speakers may be built into the device. A user devices may also have an audio port or connection through which audio output may be presented to the user. An audio port may allow a user to connect one or more external speakers to his device; such a port may alternatively allow the connection of headphones to his device, allowing the user to consume audio content in a more private manner. The use of headphones is useful, for example, if the user is in a crowd, on the street, on public transportation, etc., and he does not want to disturb those around him. The use of headphones may also enhance audio quality. In some cases, a wireless connection may be enabled, so that an audio output from a user device may be sent wirelessly to one or more external output devices, such as speakers.

Moreover, the content may be tailored to the user according to preferences of the user. He may be particularly interested in sports, foreign affairs, cat videos, and/or jazz music for example. Such preferences, when conveyed to the application by the user, may result in a user interface presentation that reflects these preferences. Content that fits these categories may be presented to the user in a manner that shows such content more prominently than other content. In some situations, content that does not fit these categories is not made available at all to the user. Content that represents a narrower subset of all available content and is brought to the attention of the user can be said to be “surfaced” in that such content is metaphorically “brought to the surface” and made more readily available to the user than other content.

### BRIEF SUMMARY

According to an embodiment of the disclosed subject matter, a user device may comprise a processor and a memory that stores instructions executable by the processor. The instructions, when executed, cause the processor to determine whether an audio output device has been connected to an audio port of the user device. When it is determined that the connection has been made, instructions may be sent to a server, instructing the server to identify only audio content. The audio content identified by the server may be identified by the server in a manner consistent with preferences of the user. The server may send one or more identifiers of the audio content to a user interface of the user device. A selection of a particular audio content item in the audio content may be received at the user device. The corresponding audio content may be received from the server. The audio content may be output via the audio port of the user device. The determining of whether a connection has been made to an audio port, the instructing of the server by the user device, and receiving may be performed by an aggregator application executing on the user device.

The connection to the audio port may be detected by an operating system of the user device. The determining that a connection has been made, as performed by the aggregator application, may comprise accessing an indication by the operating system that the connection has been made.

The user device may comprise one of a cell phone; a tablet computer; a personal computer; a laptop computer; or a wearable computer.

The disclosed subject matter may be implemented in the user device by a processor and a memory that stores instructions executable by the processor, where the instructions, when executed, cause the processor to perform the above.

The disclosed subject matter may be implemented at least in part by a computer program product comprising a non-transitory medium that stores executable instructions which, when executed on a processor, cause the processor to perform the above processing.

A user device may alternatively comprise a processor and a memory that stores instructions executable by the processor where the instructions, when executed, cause the processor to determine whether an audio output device has been connected to an audio port of the user device; when it has been determined that the connection has been made, the instructions cause the processor to identify audio content and make the audio content available to a user, to the exclusion of other types of content.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a network in which an embodiment of the disclosed subject matter may operate.

FIG. 2 shows communications between a user device and a server, according to an embodiment of the disclosed subject matter.

FIG. 3 is a flow chart illustrating operation of a user device according to an embodiment of the disclosed subject matter.

FIG. 4 is a flow chart illustrating operation of a server according to an embodiment of the disclosed subject matter.

FIG. 5 is a block diagram illustrating the components of a user device and their connectivity.

### DETAILED DESCRIPTION

In a user device, a determination is made as to whether a connection has been made to an audio port of the user device. When it has been determined that the connection has been made, a server is instructed to identify audio content. The audio content is then received from the server. For example, a smartphone may detect that wired or wireless headphones have been connected to the smartphone. The smartphone may then notify a content provider server to identify and/or provide audio content to the device. As a specific example, a content aggregation application may instruct one or more content providers to limit the content provided to the app to only audio content upon the smartphone detecting the headphone connection. The application may then present only audio content to a user of the device.

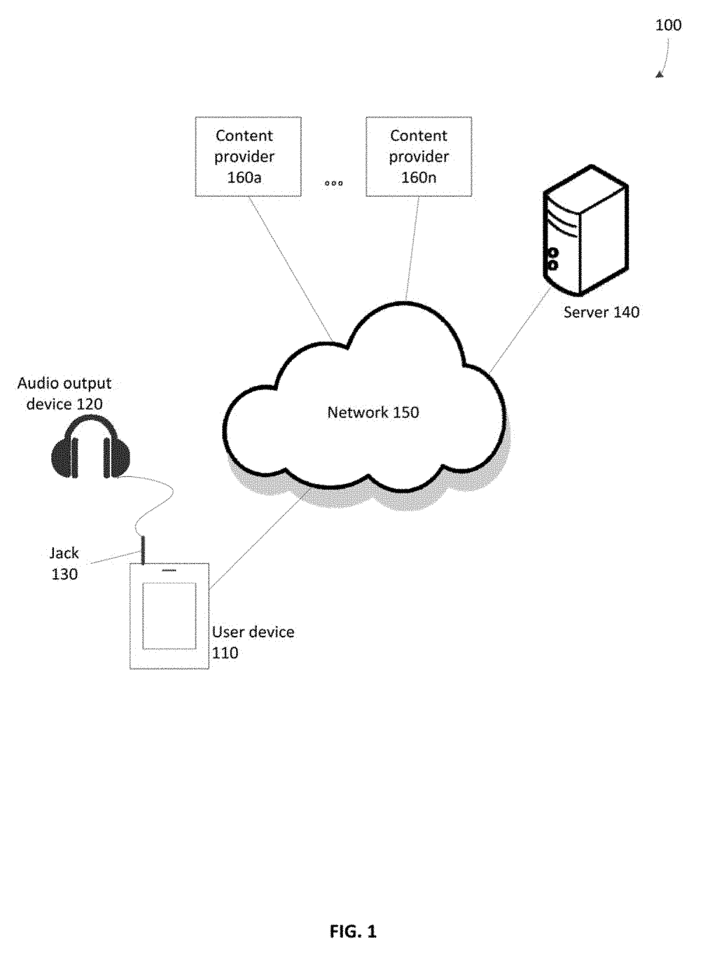

FIG. 1 illustrates an arrangement in which an embodiment of the disclosed subject matter may function. A user device 110 may be in communication with a server 140. This communication may be implemented through a network 150. The network 150 may be a local area network, a wide area network, an internet, or any combination thereof. One or more content providers 160a . . . 160n may also be connected to the server 140 via the network 150.

The content providers 160a . . . 160n may correspond to news sources such as newspapers, broadcast radio networks, wire services, or cable news outlets. They may alternatively or in addition correspond to social media sites, podcast services, or music or video services, for example and without limitation. In an embodiment, such content providers 160 may provide content to the server 140. The content may then be made available to user devices, including user device 110. Alternatively, content providers 160 may provide content directly to user device 110 without going through a server.

In an embodiment, the user may attach an audio output device 120 to the user device 110. In the example illustrated, the audio output device 120 is a set of headphones. This output device 120 is connected to the user device through one or more wires terminating in a jack 130. The jack 130 may be plugged into an audio port, e.g., a physical connector, on user device 110 in order to route audio output to the audio output device 120. While the audio output device 120 is shown as a set of headphones, the audio output device 120 may alternatively be one or more external speakers that are connected to the user device 110 through a similar wired connection. Alternatively, the connection may not be wired; instead, an audio output device may be connected to the user device 110 through a wireless connection. Such a wireless connection maybe effected using a wireless protocol, such as Bluetooth® for example. In this case, the audio port may be viewed as hardware components and/or software module(s) in the user device that implement the wireless connection to the audio output device. In the wireless case, the audio output device may be a speaker or headphones, for example.

In an embodiment, the audio output device 120 is connected to the user device 110 via jack 130. The connection of jack 130 is detected by an aggregator application running on the user device 110. In an embodiment, this detection may take place via the operating system of the user device 110, as will be discussed further below. When this connection is detected by the aggregator application, the user device 110 communicates with the server 140, instructing server 140 to identify (or “surface”) content for the user, but only audio content. The term audio content, as used herein, refers to any content that includes audio data. Examples may include strictly audio data (such as music), or content that includes video and audio (such as a music video or video news story), or content that includes both text and audio (such as a news article that includes audio). Content having no audio data may not be surfaced. The audio content may then be presented to the user through the aggregator application (or other application) running on the user device 110. In this manner, the user's desire for content that includes audio content is inferred by his connection of an audio output device 120 to the user device 110. Audio content may be consequently surfaced at the server 140 and made accessible to the user.

In an embodiment where the content is provided directly from content provider(s) to the aggregator application on user device 110 (without an intermediate server), the aggregator application may perform the surfacing of the audio content. This application may determine whether an audio output device has been connected to an audio port of the user device 110. When it has been determined that the connection has been made, the application may identify audio content and make the audio content available to a user, to the exclusion of other types of content.

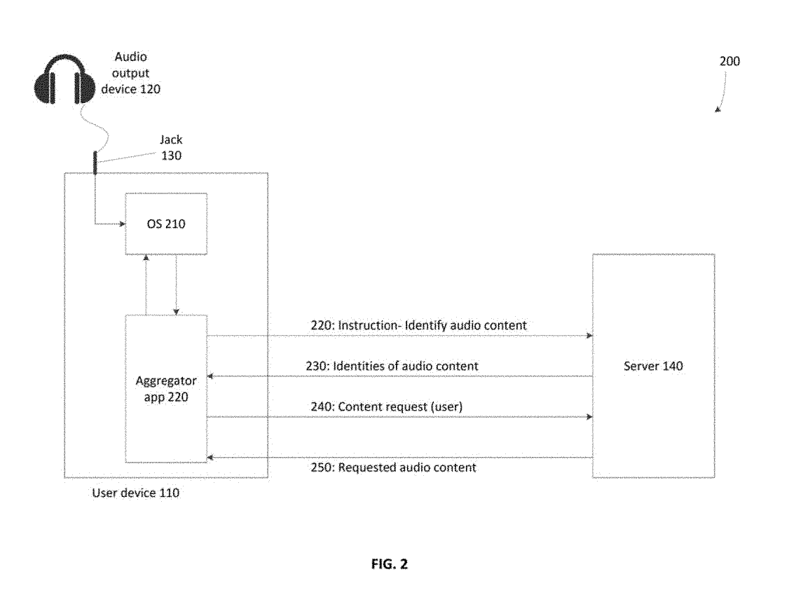

Communication between the user device 110 and server 140 is illustrated in FIG. 2, according to an embodiment. Here, the user device 110 includes an operating system (OS) 210. The OS 210 detects the connection of the jack 130. In an embodiment, the connection of jack 130 may result in the setting of a binary flag by OS 210, denoting that this connection is in place. In a wireless embodiment, the establishment of a wireless connection between user device 110 and an audio output device may result in the setting of such a flag.

The aggregator application 220 may poll the OS 210 to determine if the flag has been set. If it is determined if this flag is set, then the aggregator application 220 may send a communication 220 to the server 140, instructing the server 140 to identify content for the user, but only audio content. Server 140 may then respond by identifying this content and sending the identities of the identified content items to the aggregator application 220. These identities may include file names or other identifiers of the audio content. The identities of the audio content can also include graphics that may be displayed to the user through the user interface of the aggregator application. The graphics may be specific to the audio content for example (e.g., an album cover or a photo of a singer) and/or relate to a content provider (e.g., a recording label or a logo for a news service).

In an embodiment, the audio content identified by server 140 may be constrained by a number of factors, such as whether the user has been authenticated and/or has access rights to particular content. The identified content may also be constrained by previously specified preferences of the user. The audio content may be identified by the server 140 only if it is consistent with his stated preferences. If the user has stated a preference for bluegrass music only, such content may be identified, while opera may not, for example.

At aggregator application 220, a user interface may show the user what audio content is available to him, as identified by the server in communication 230. As noted above, the user interface may also include graphics that may have been provided in communication 230. The user may then select a particular item of audio content. This selection may then be conveyed from the aggregator application 220 to the server 140 as a request 240 for the actual user-selected audio content. The server 140 may then respond by providing the requested audio content to the aggregator application 220 in communication 250. The requested audio content may then be provided to the user's audio output device 120 via the jack 130 (or via a wireless connection to the audio output device 120 in a wireless embodiment).

It is to be understood that while communications 220-250 are each shown as single communications, FIG. 2 is meant as an illustration. Any or all of the communications 220-250 may in fact include more than one physical transmission. Depending on a communications protocol in use, a communication may actually include several packetized or otherwise segmented transmissions for example. Further, some or all of such segments may require subsequent acknowledgements moving in the opposite direction.

Moreover, as noted above, the processing described herein may not use a server 140. Instead, some or all of the operations ascribed herein to the server 140 may be performed at the user device 110, e.g., at application 220. The application 220 may be in contact with content providers without an intermediate server, such that the application 220 identifies the audio content for presentation to the user, to the exclusion of other types of content.

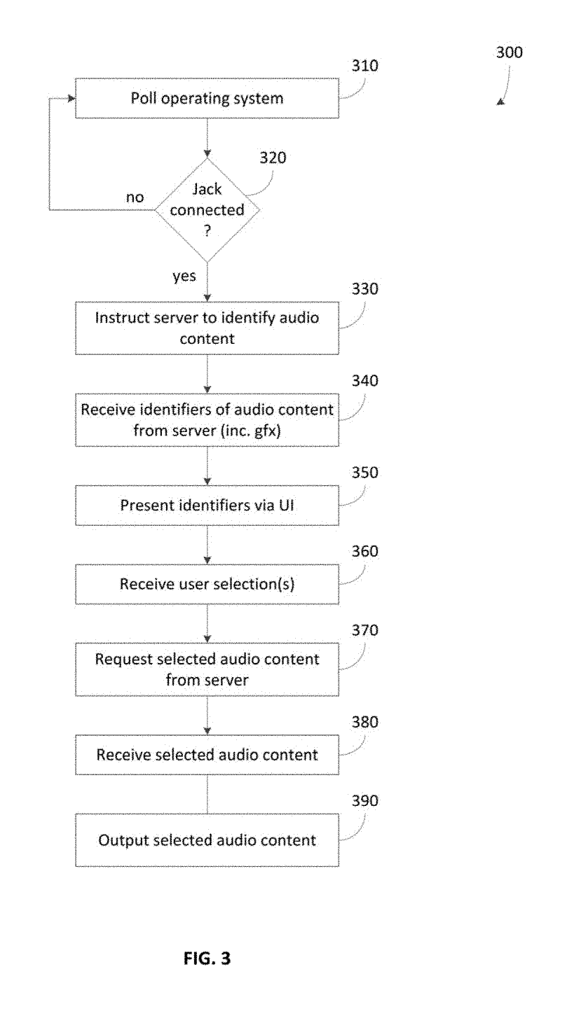

Processing at the user device 110 is shown in FIG. 3, according to an embodiment. At 310, the aggregator application may poll the OS to determine if a flag has been set indicating that a jack has been connected to an audio port of the user device. At 320, a determination may be made as to whether a jack is connected. In a wireless embodiment, a determination would be made as to whether a wireless connection has been made with an audio output device. In either event, if a connection is not detected, polling may continue at 310; if so, processing may continue at 330. Here, the server is instructed to identify audio content.

At 340, the aggregator application may receive identifiers of the audio content identified at the server. As discussed above, this may also include graphics (gfx) related to the identified audio content. At 350, the aggregator application may present identifiers of the audio content to the user through a user interface (UI) of the application. At 360, the aggregator application may receive one or more selections from the user. The selection(s) may be received via the UI.

At 370, the aggregator application may request the selected audio content from the server. At 380, the selected audio content may be received at the user device. At 390, the audio content may be output to the user's audio output device via the jack or a wireless connection, upon the command of the user.

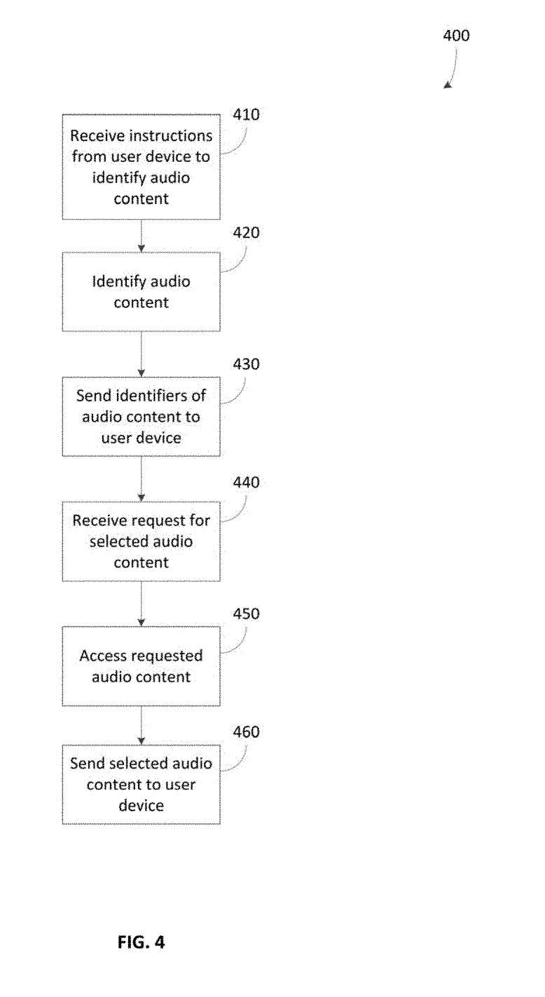

Processing at the server 140 is shown in FIG. 4, according to an embodiment. At 410, the server may receive instructions from the user device to identify only audio content. At 420, the server may identify such content. As discussed above, audio content may include any content having an audio component. Moreover, the identification of such content for the user may be constrained by limitations on the content to which the user is permitted access and/or the user's preferences. In an embodiment, if the server maintains a playlist of content items having a variety of media types (e.g., audio content items, video content items, and text content items, etc.), the server may prioritize or otherwise rearrange the playlist to place the audio content items higher in the playlist than they would otherwise be. At 430, identifiers of the audio content surfaced by the server may be sent to the user device. In an embodiment, these identifiers may include graphics associated with the identified audio content.

At 440, the server may receive a request for some or all of the surfaced audio content. The specifically requested audio content may have been chosen by the user, for example. At 450, the server may access the requested audio content. In an embodiment, this requested content may have been previously archived at the server so that accessing the requested content would comprise reading this content from local memory. Alternatively, the server may access the requested content by contacting the respective content providers and receiving this content from them. At 460, the server may send the requested audio content to the user device.

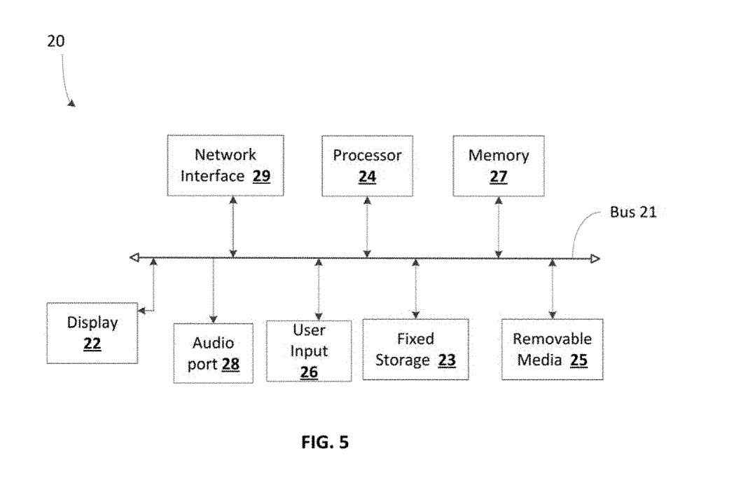

Embodiments of the presently disclosed subject matter may be implemented in and used with a variety of component architectures. FIG. 5 is an example computing device 20 suitable for implementing embodiments of the presently disclosed subject matter. The device 20 may represent, for example, a user device such as a desktop or laptop computer, or a mobile computing device such as a smart phone, tablet, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, and the like. In some devices, such as a tablet or smart phone, the display 22 and the user input interface 26 may be the same component (e.g., a touch screen). Device 20 may also include fixed storage 23 such as a hard drive, flash storage, and the like, a removable media component 25 operative to control and receive an optical disk, flash drive, and the like, and a network interface 29 operable to communicate with one or more remote devices via a suitable network connection. Device 20 may also include an audio port 28. Where device 20 represents a user device, connection of a jack to port 28 may be noted by an operating system. By polling the operating system, an aggregator application may be made aware of the connection of the jack, as discussed above.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 (e.g., aggregator application 220 of FIG. 2) are generally stored on and accessed via a computer readable medium, such as a hard disk drive (e.g., fixed storage 23), an optical drive, floppy disk, RAM, ROM, flash, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like.

For example, the network interface 29 may allow the computer to communicate with other computers (such as server 140 shown in FIG. 1) via one or more local, wide-area, or other communication networks (such as network 150 shown in FIG. 1).

Many other devices or components (not shown) may be connected in a similar manner (e.g., document scanners, digital cameras and so on). Conversely, all of the components shown in FIG. 5 need not be present to practice the present disclosure. The components can be interconnected in different ways from that shown. Code to implement the present disclosure (e.g., aggregator application 220 of FIG. 2) can be stored in computer-readable storage media such as one or more of the memory 27, fixed storage 23, removable media 25, or on a remote storage location.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions.

Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
at a user device, determining whether an audio output device has been connected to an audio port of the user device;
when it has been determined that the connection has been made, sending a request to a server, wherein the request instructs the server to identify only audio content; and
receiving the audio content.

2. The method of claim 1, further comprising:
outputting the audio content via the audio port.

3. The method of claim 1, further comprising:
sending one or more identifiers of the audio content to a user interface of the user device; and
receiving a selection of a particular audio content item in the audio content.

4. The method of claim 1, wherein the user device comprises one of:
a cell phone;
a tablet computer;
a personal computer;
a laptop computer; or
a wearable computer.

5. The method of claim 1, wherein the determining, sending, and receiving are performed by an aggregator application executing on the user device.

6. The method of claim 5, wherein the connection is detected by an operating system of the user device.

7. The method of claim 6, wherein the determining that a connection has been made, as performed by the aggregator application, comprises accessing an indication by the operating system that the connection has been made.

8. The method of claim 1, wherein the audio content identified by the server is identified by the server in a manner consistent with preferences of the user.

9. A user device, comprising:
a processor; and
a memory that stores instructions executable by the processor, where the instructions, when executed, cause the processor to:
determine whether an audio output device has been connected to an audio port of the user device;
when it has been determined that the connection has been made, send a request to a server, wherein the request instructs the server to identify only audio content; and
receive the audio content.

10. The user device of claim 9, where the instructions, when executed, further cause the processor to output the audio content via the audio port.

11. The user device of claim 9, where the instructions, when executed, further cause the processor to:
send one or more identifiers of the audio content to a user interface of the user device; and
receive a selection of a particular audio content item in the audio content.

12. The user device of claim 9, wherein the user device comprises one of:
a cell phone;
a tablet computer;
a personal computer;
a laptop computer; or
a wearable computer.

13. The user device of claim 9, wherein the instructions represent at least part of an aggregator application executing on the user device.

14. The user device of claim 13, wherein the connection is detected by an operating system of the user device.

15. The user device of claim 14, wherein the determination that the connection has been made, as performed by the aggregator application, comprises accessing an indication by the operating system that the connection has been made.

16. The user device of claim 9, wherein the audio content identified by the server is identified by the server in a manner consistent with preferences of the user.

17. The user device of claim 9, wherein the audio output device is one or more of a set of headphones and an external speaker.

18. A computer program product comprising a non-transitory medium that stores executable instructions which, when executed on a processor, cause the processor to:
determine whether an audio output device has been connected to an audio port of a user device;
when it has been determined that the connection has been made, send a request to a server, wherein the request instructs the server to identify audio content; and
receive the audio content.

19. The computer program product of claim 18, where the instructions, when executed, further cause the processor to output the audio content via the audio port.

20. The computer program product of claim 18, where the instructions, when executed, further cause the processor to:
send one or more identifiers of the audio content to a user interface of the user device; and
receive a selection of a particular audio content item in the audio content.

21. The computer program product of claim 18, wherein the instructions represent at least part of an aggregator application executing on the user device.

22. The computer program product of claim 21, wherein the connection is detected by an operating system of the user device.

23. The computer program product of claim 22, wherein the determination that a connection has been made, as performed by the aggregator application, comprises accessing an indication by the operating system that the connection has been made.

24. A user device, comprising:
a processor; and
a memory that stores instructions executable by the processor, where the instructions, when executed, cause the processor to:
determine whether an audio output device has been connected to an audio port of the user device;
when it has been determined that the connection has been made, identify audio content; and
make the audio content available to a user, to the exclusion of other types of content.
